(19) United States
(12) Patent Application Publication
(10) Pub. No.: US 2024/0280459 A1
(43) Pub. Date: Aug. 22, 2024

(54) EVALUATION APPARATUS AND EVALUATION METHOD

(71) Applicant: Kioxia Corporation, Tokyo (JP)

(72) Inventors: Yusuke OSHIMA, Yokkaichi Mie (JP); Toshiyuki MURANAKA, Yokkaichi Mie (JP); Kyo OTSUBO, Yokkaichi Mie (JP); Ryutaro OTAHARA, Yokkaichi Mie (JP); Motonari TAKAHASHI, Yokkaichi Mie (JP); Hiroshi TOMITA, Niwa Aichi (JP); Kazuki BABA, Yokkaichi Mie (JP)

(73) Assignee: Kioxia Corporation, Tokyo (JP)

(21) Appl. No.: 18/582,450

(22) Filed: Feb. 20, 2024

(30) Foreign Application Priority Data
Feb. 21, 2023 (JP) 2023-025090

(51) Int. Cl. G01N 15/0205; G01N 1/40

(52) U.S. Cl. CPC G01N 15/0211; G01N 1/4077; G01N 2001/4088

(57) ABSTRACT

An evaluation apparatus according to an embodiment includes an evaluator including a column being capable of storing a liquid containing defects, the column being transparent, the defects containing a bubble, a first particle containing metal, and a second particle being different from the bubble and the first particle, an irradiator irradiating the liquid in the column with an irradiation light, an imager imaging a scattered light emitted from the defects by the irradiation light, an analyzer obtaining a diffusion coefficient of the defects from the imaged scattered light, a calculator calculating a particle size and a refractive index of the defects, a determiner determining whether the defects contain the bubble or the second particle, or the first particle; a filter filtering the liquid, the filter including an inlet and an outlet; a first pipe connecting the outlet of the filter and the evaluator.

### CROSS-REFERENCE TO RELATED APPLICATION

This application is based upon and claims the benefit of priority from Japanese Patent Application No. 2023-025090, filed on Feb. 21, 2023, the entire contents of which are incorporated herein by reference.

### FIELD

Embodiments described herein relate generally to an evaluation apparatus and an evaluation method.

### BACKGROUND

In a manufacturing process of a semiconductor device, various liquids (chemical liquids) are used. Liquids used in the manufacturing process of the semiconductor device contain defects (the defects in the liquid) such as bubbles, metallic particles, and other particles. The presence of such defects causes geometry defects of a device in forming microfabrication of the semiconductor device. Therefore, the yield of the semiconductor device is reduced. Therefore, the defects are removed by filtering the liquid using a filter for the liquid prior to feeding the liquid to the semiconductor manufacturing apparatus.

### BRIEF DESCRIPTION OF THE DRAWINGS

FIG. 1 is a schematic diagram of the evaluation apparatus of an embodiment.

FIG. 2 is a schematic diagram of a filter unit of the embodiment.

FIGS. 3A-B are schematic diagrams of an evaluation unit of the embodiment.

FIG. 4 is an example of an evaluation of the liquid containing the defects performed using the evaluation apparatus of the embodiment.

FIG. 5 is another example of the evaluation of the liquid containing the defects performed using the evaluation apparatus of the embodiment.

FIG. 6 is another example of the evaluation of the liquid containing the defects performed using the evaluation apparatus of the embodiment.

FIG. 7 shows filter flow rate dependency of number of defects performed using the evaluation apparatus of the embodiment for Example 1.

FIG. 8 shows the filter flow rate dependency of the number of defects performed using the evaluation apparatus of the embodiment for Example 2.

FIGS. 9A-B show the filter flow rate dependency of the number of defects performed using the evaluation apparatus of the embodiment for Example 3.

### DETAILED DESCRIPTION

An evaluation apparatus according to an embodiment includes an evaluator including a column being capable of storing a liquid containing defects, the column being transparent, the defects containing a bubble, a first particle containing metal, and a second particle being different from the bubble and the first particle, an irradiator irradiating the liquid in the column with an irradiation light, an imager imaging a scattered light emitted from the defects by the irradiation light, an analyzer obtaining a diffusion coefficient of the defects from the imaged scattered light, a calculator calculating a particle size and a refractive index of the defects, a determiner determining whether the defects contain the bubble or the second particle, or the first particle; a filter filtering the liquid, the filter including an inlet and an outlet; a first pipe connecting the outlet of the filter and the evaluator.

Hereinafter, embodiments will be described with reference to the drawings. In the drawings, the same or similar parts are denoted by the same or similar reference numerals.

### Embodiment

An evaluation apparatus according to an embodiment includes an evaluator including a column being capable of storing a liquid containing defects, the column being transparent, the defects containing a bubble, a first particle containing metal, and a second particle being different from the bubble and the first particle, an irradiator irradiating the liquid in the column with an irradiation light, an imager imaging a scattered light emitted from the defects by the irradiation light, an analyzer obtaining a diffusion coefficient of the defects from the imaged scattered light, a calculator calculating a particle size and a refractive index of the defects, a determiner determining whether the defects contain the bubble or the second particle, or the first particle; a filter filtering the liquid, the filter including an inlet and an outlet; a first pipe connecting the outlet of the filter and the evaluator.

An evaluation method according to an embodiment includes filtering a liquid containing defects by a filter, the defects containing a bubble, a first particle containing metal, and a second particle being different from the bubble and the first particle; delivering the filtered liquid to a column, the column being transparent; irradiating the liquid in the column with an irradiation light; imaging a scattered light emitted from the defects by the irradiation light; obtaining a diffusion coefficient of the defects from the imaged scattered light; calculating a particle size and a refractive index of the defects; and determining whether the defects contain the bubble or the second particle, or the first particle.

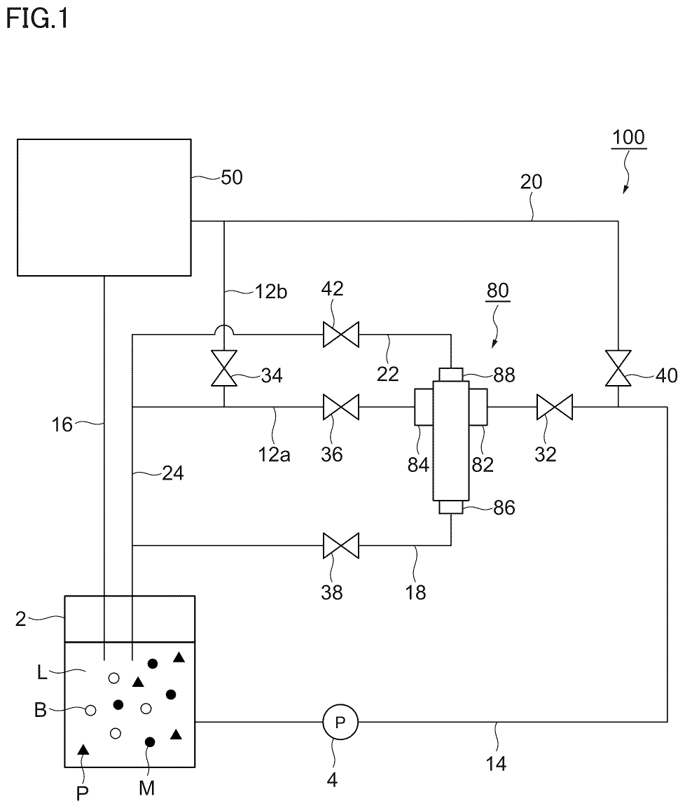

FIG. 1 is the schematic diagram of the evaluation apparatus 100 of the embodiment.

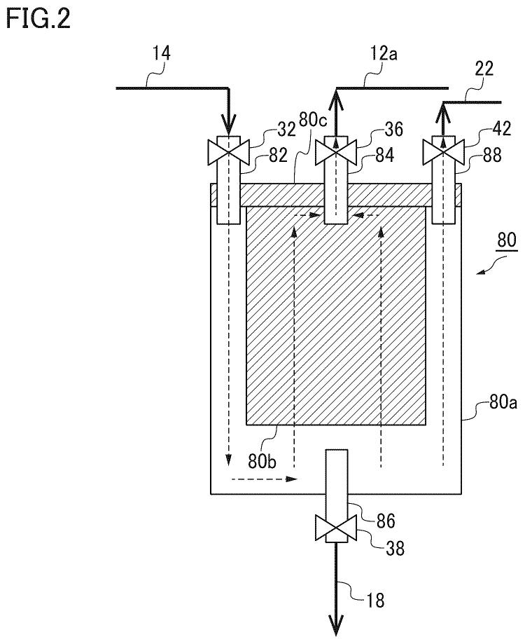

FIG. 2 is the schematic diagram of the filter unit 80 of the embodiment.

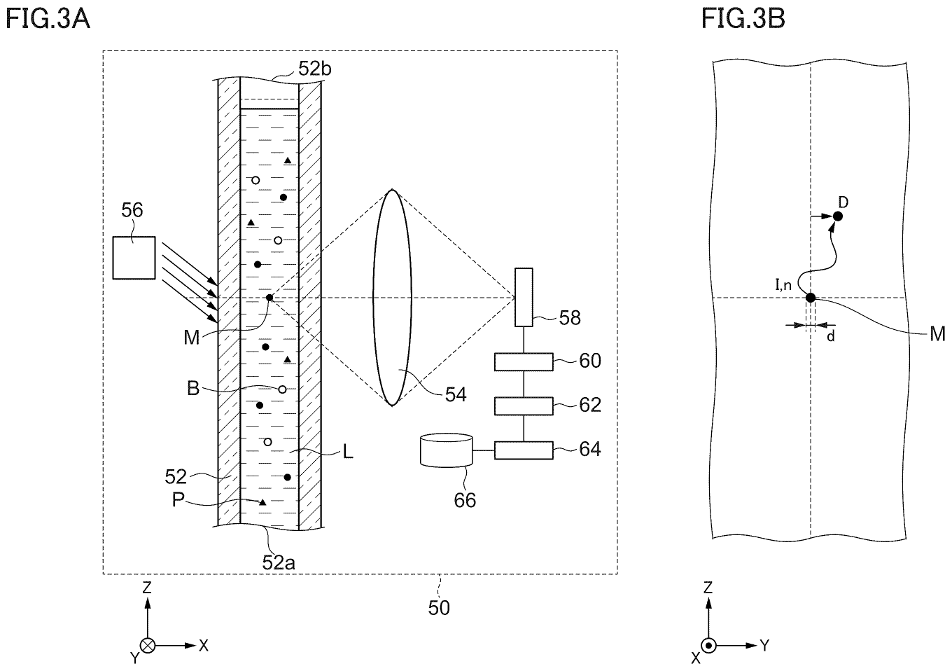

FIGS. 3A-B are the schematic diagrams of the evaluation unit 50 of the embodiment.

The evaluation apparatus 100 of the embodiment will be described using FIG. 1, FIG. 2, and FIGS. 3A-B.

The evaluation apparatus 100 includes a storage tank 2, a liquid feed pump (a pump) 4, a first pipe 12, a second pipe 14, a third pipe 16, a fourth pipe 18, a fifth pipe 20, a sixth pipe 22, a seventh pipe 24, a first valve 32, a second valve 34, a third valve 36, a fourth valve 38, a fifth valve 40, a sixth valve 42, the evaluation unit (an evaluator) 50, and the filter unit 80.

The evaluation unit 50 includes a column 52, a lens 54, an irradiator (a laser light irradiator, a laser light irradiation unit) 56, an imaging unit (an imager) 58, an analyzing unit (an analyzer) 60, a determining unit (a determiner) 64, and a database 66.

The filter unit 80 includes a container 80a, a filter 80b, a lid 80c, an inlet 82, a first outlet 84, a second outlet 86, and a third outlet 88.

The storage tank 2 is a container that stores the liquid Q.

The liquid Q is, for example, a chemical liquid used in the semiconductor manufacturing process. The liquid Q is preferably, for example, a chemical solution containing a quaternary amine, a chemical solution containing a quaternary amine and a surfactant, or a chemical solution containing water and a surfactant. However, the type of the liquid Q is not particularly limited to those described above.

The chemical solution containing a quaternary amine is preferably an aqueous tetramethylammonium hydroxide solution (TMAH) or an aqueous trimethyl-2-hydroxyethylammonium hydroxide solution.

The liquid Q contains the bubble B, a first particle M containing metal, and a second particle P that differs from the bubble B and the first particle M. The first particle M is a particle of silver, gold, iron hydroxide oxide or chromium oxide, and so on. The second particle P is, for example, carbon, silica (quartz) or fluororesin.

In the present specification, the bubble B, the first particle M, and the second particle P are collectively referred to as the defects (the defects in the liquid).

The second pipe 14 is a pipe connecting the storage tank 2 and the inlet 82 of the filter unit 80.

The liquid feed pump 4 is provided at the second pipe 14. The liquid feed pump 4 delivers the liquid in the storage tank 2 to the filter unit 80. The flow rate of the liquid Q fed to the filter unit 80 can be controlled by the first valve 32 provided at the second pipe 14.

The first pipe 12 is a pipe connecting the first outlet (outlet) 84 of the filter unit 80 and the column inlet 52a. The first pipe 12 has a first pipe 12a connected to the first outlet 84 and a first pipe 12b connecting the first pipe 12a and the column inlet 52a. The third valve 36 is provided at the first pipe 12a. The second valve 34 is provided at the first pipe 12b.

The third pipe 16 is a pipe connecting the column outlet 52b of the column 52 and the storage tank 2.

The fourth pipe 18 is a pipe connecting the second outlet 86 of the filter unit 80 and the storage tank 2. The fourth valve 38 is provided at the fourth pipe 18.

The fifth pipe 20 is a pipe connecting the first pipe 12 between the liquid feed pump 4 and the first valve 32, and the column inlet 52a. The fifth valve 40 is provided at the fifth pipe 20.

The sixth pipe 22 is a pipe connecting the third outlet 88 of the filter unit 80 and the storage tank 2. The sixth valve 42 is provided at the sixth pipe 22.

The seventh pipe 24 is a pipe connecting the first pipe 12a, the fourth pipe 18, the sixth pipe 22, and the storage tank 2. The first pipe 12a, the fourth pipe 18, and the sixth pipe 22 are connected to the storage tank 2 via the seventh pipe 24.

The filter unit 80 (FIG. 2) is a non-cartridge type filter unit. The filter 80b is provided in the container 80a. The lid of the container 80a is performed by the lid 80c. The liquid Q fed from the inlet 82 into the filter unit 80 is filtered by the filter 80b and discharged from the first outlet 84. The sixth pipe 22 is a pipe for discharging the bubble in the liquid Q. By opening the sixth valve 42, the bubble in the fluid Q can be discharged through the sixth pipe 22. In addition, the liquid Q fed to the filter unit 80 by the first pipe 12 is discharged from the second outlet 86, so that the liquid Q can be discharged to the outside of the filter unit 80 without being filtered by the filter 80b. Although the filter unit such as that shown in FIG. 2 is exemplified here, the embodiment is not limited to this, and the embodiment can employ various types of the filter unit.

The inlet 82 of the filter unit 80 is the inlet of the filter 80b. The first outlet 84 of the filter unit 80 is an outlet of the filter 80b.

The pore size of the filter 80b is preferably 100 nm or less.

Note that the shape of the filter unit 80 illustrated in FIG. 1 and the shape of the filter unit 80 illustrated in FIG. 2 do not necessarily coincide with each other for ease of explanation. In addition, the form of the filter or the filter unit preferably used in the embodiment is not limited to those illustrated in FIG. 1 and FIG. 2.

When the liquid Q is passed through the filter 80b, the first valve 32 and the third valve 36 are opened and the second valve 34, the fourth valve 38, the fifth valve 40, and the sixth valve 42 are closed. The liquid Q in the storage tank 2 is pumped by the liquid feed pump 4 through the second pipe 14 and the first valve 32 into the filter unit 80. The liquid Q filtered by the filter 80b in the filter unit 80 passes through the third valve 36, the first pipe 12a and the seventh pipe 24 and returns to the storage tank 2. By continuing to drive the liquid feed pump 4, the liquid Q can be continuously filtered by the filter 80b.

When evaluating the number of defects in the liquid Q prior to passing the liquid Q through the filter 80b, the first valve 32, the fourth valve 38 and the fifth valve 40 are opened, and the second valve 34, the third valve 36 and the sixth valve 42 are closed. The liquid Q in the storage tank 2 passes through the fourth valve 38 from the first valve 32 as it passes through the filter unit 80. Therefore, the liquid Q in the storage tank 2 is not filtered by the filter 80b. A portion of the liquid Q is fed from the fifth valve 40 to the evaluation unit 50 through the fifth pipe 20. Thereafter, the liquid Q fed to the evaluation unit 50 returns to the storage tank 2 via the third pipe 16.

When evaluating the number of defects in the liquid Q after passing the liquid Q through the filter 80b, the first valve 32, the second valve 34 and the third valve 36 are opened, and the fourth valve 38, the fifth valve 40 and the sixth valve 42 are closed. The liquid Q filtered by the filter 80b is fed to the evaluation unit 50 through the second valve 34 and the first pipe 12b. This allows the evaluation unit 50 to be used to evaluate the defects in the liquid Q.

The evaluation unit 50 obtains the particle size (geometric diameter) of the defect by FPT (Flow Particle Tracking) method.

FIG. 3A is the schematic diagram of the evaluation unit 50 of the embodiment.

Here, an X-axis, a Y-axis intersecting perpendicularly to the X-axis, and a Z-axis intersecting perpendicularly to the X-axis and the Y-axis are defined. The Z-axis is opposite to the vertical direction.

The column 52 is a container that is transparent and capable of containing the liquid Q. The flow of the liquid Q in the column 52 is a laminar flow flowing along the Z-axis. The column 52 is formed of, for example, synthetic quartz or sapphire. The first pipe 12b and the fifth pipe 20 are connected to the column inlet 52a of the column 52. The third pipe 16 is connected to the column outlet 52b of the column 52. The liquid Q in the column 52 passes through the column 52 and then returns to the storage tank 2. Then, the liquid Q is fed to the filter 80b by the liquid feed pump 4 again and filtered by the filter 80b. In this way, the liquid Q can be filtered using the filter 80b while the liquid Q is circulated in the evaluation apparatus 100.

The irradiator (light source) 56 irradiates the liquid Q in the column 52 with the irradiation light such as a laser light. For example, when the liquid Q in the column 52 flows in the Z-axis direction, the irradiator 56 irradiates the liquid Q with the irradiation light in the X-axis direction. Note that the irradiation direction of the irradiation light is not limited to the X-axis direction.

The imaging unit 58 includes a CCD (Charge Coupled Device) sensor, a CMOS (Complementary Metal Oxide Semiconductor) sensor, or the like. The imaging unit 58 uses the lens 54 or the like to image the liquid Q in the column 52. Then, moving images of the scattered light emitted from the bubble B, the first particle M, and the second particle P contained in the liquid are acquired. FIG. 3B is an example of the schematic diagram of the moving images of the first particle M acquired by the imaging unit 58. The analyzing unit 60 obtains the diffusion coefficient D of the bubble B, the first particle M, and the second particle P from the moving images.

When the defect performs Brownian motion in the liquid Q, the moving image of the scattered light of the defect can be used to determine the diffusion coefficient D of the defect. The particle size d of the diffusion coefficient D and the defect are connected by the equation below.

$$\begin{matrix}[ Mathematical formula 1 ] & \\ D = \frac{{k}_{B} T}{3 πη d} & ( 1 )\end{matrix}$$

In Equation (1), D is the diffusion coefficient of the defect, k_{B} is the Boltzmann's constant, T is the absolute temperature, η is the viscosity (viscosity factor) of the liquid Q, and d is the particle size of the defect. The calculating unit 62 can determine the particle size d of the defect from the diffusion coefficient D using Equation (1).

In addition, the refractive index of the defect can be obtained from the following equation.

$$\begin{matrix}[ Mathematical formula 2 ] & \\ 1 ∝ {I}_{0} \frac{c}{2 {r}^{2}} {( \frac{2 π}{λ} )}^{4} {( \frac{d}{2} )}^{6} {\vert \frac{{m}^{2} - 1}{{m}^{2} + 2} \vert}^{2} & ( 2 )\end{matrix}$$

In equation (2), I is the intensity of the scattered light, I₀ is the intensity of the incident light, c is the number concentration of the defects, ris the distance from the defect to the imaging unit 58, λ is the wavelength of the incident light, d is the particle size of the defect, and m is the relative refractive index of the defect to the liquid Q. The relative refractive index m is the refractive index n of the defect divided by the refractive index no of fluid Q (m=n/n0). When the refractive index no of the liquid Q is known, the calculating unit 62 can determine the refractive index n of the defect using Equation (2).

The determining unit 64 uses the refractive index n determined by the calculating unit 62 to determine whether the defect is the bubble or the second particle P, or the first particle M. For example, the determining unit 64 is connected to the database 66 in which the refractive index of a known substance is stored. For example, the determining unit 64 determines whether the defect is the bubble or the second particle P, or the first particle M, referring to the refractive index of such known substance.

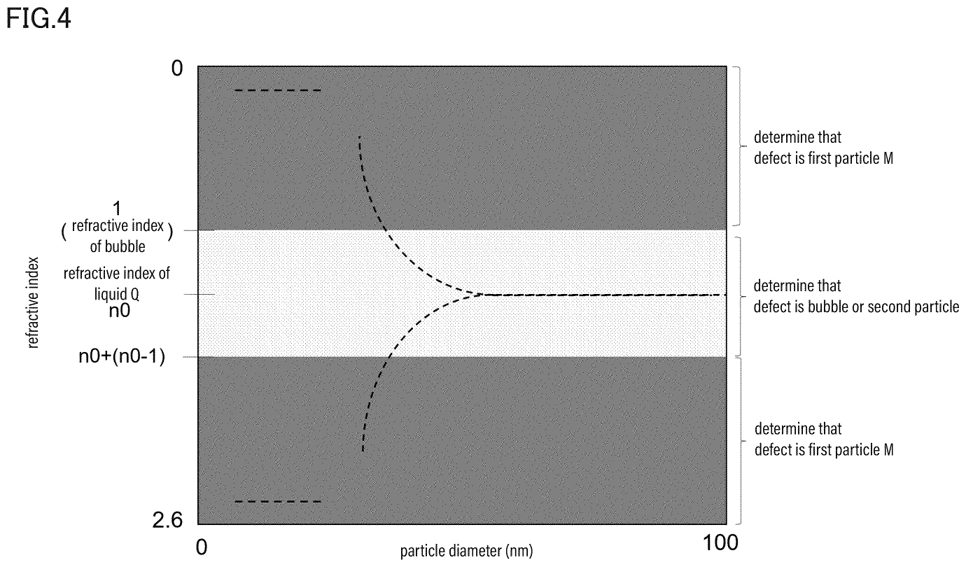

FIG. 4 is the example of the evaluation of the liquid containing the defects performed using the evaluation apparatus of the embodiment. The graph shown in FIG. 4 is the particle size d of the defect with the horizontal axis and the refractive index n calculated by the calculating unit 62 with the vertical axis.

FIG. 4 shows similar distributions at the top and the bottom, centered on the refractive index no of liquid Q. In other words, the calculating unit 62 provides two refractive indices n around the refractive index no of the liquid Q for the same the particle size d. This is because Equation (2) is a quadratic equation of the relative refractive index m. Therefore, by comparing the relative refractive index m obtained by Equation (2) with known refractive index data, the evaluation method of the embodiment becomes a semi-qualitative method.

Specifically, when the refractive index of the liquid Q to be measured is no, it is preferable that the determining unit 64 determines that the defects contain the first particle M when the refractive index n is larger than n0+(n0−1) or the refractive index n is smaller than 1. When the refractive index of the liquid Q to be measured is no, it is preferable that the determining unit 64 determines that the defects contain the bubble or the second particle P when the refractive index n is 1 or more or the refractive index n is n0+(n0−1) or less. In other words, centered on the refractive index no of the liquid Q, when the refractive index n within the range of the difference between the refractive index no of the liquid Q and the refractive index 1 of the bubble is calculated, it is determined that the defects contain the second particle P or the bubble. Further, centered on the refractive index no of the liquid Q, when the refractive index n out of the range of the difference between the refractive index no of the liquid Q and the refractive index 1 of the bubble is calculated, it is determined that the defects contain the first particle M. The refractive index no of the liquid Q to be measured is, for example, 1.2 to 1.5, but is not limited thereto.

Note that the database 66 may not be provided. The determining unit 64 may distinguish the bubble from the metallic particles by simply using the magnitude relation of the refractive index.

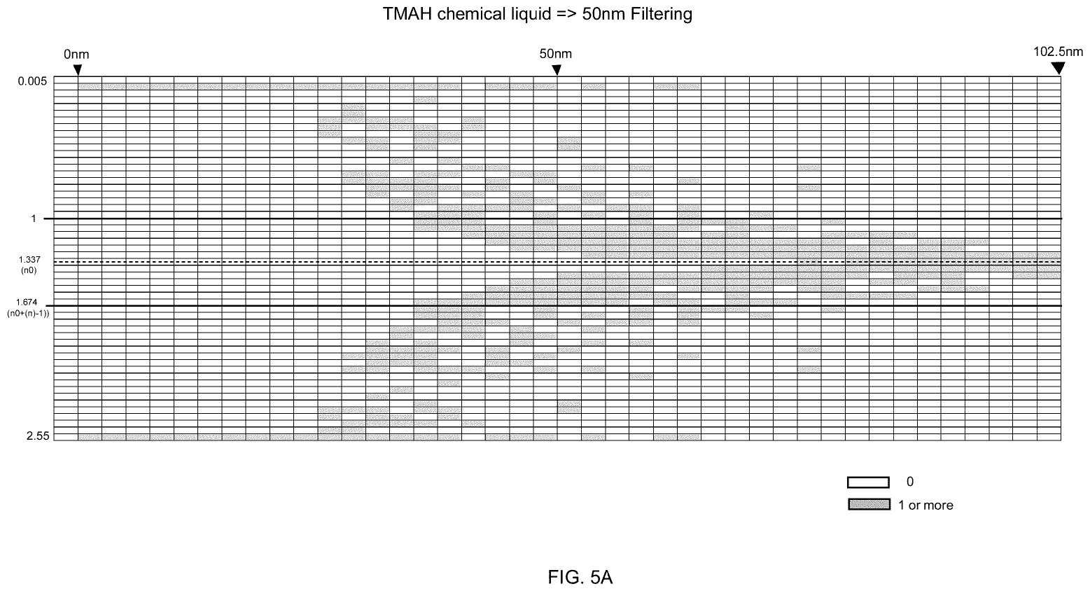

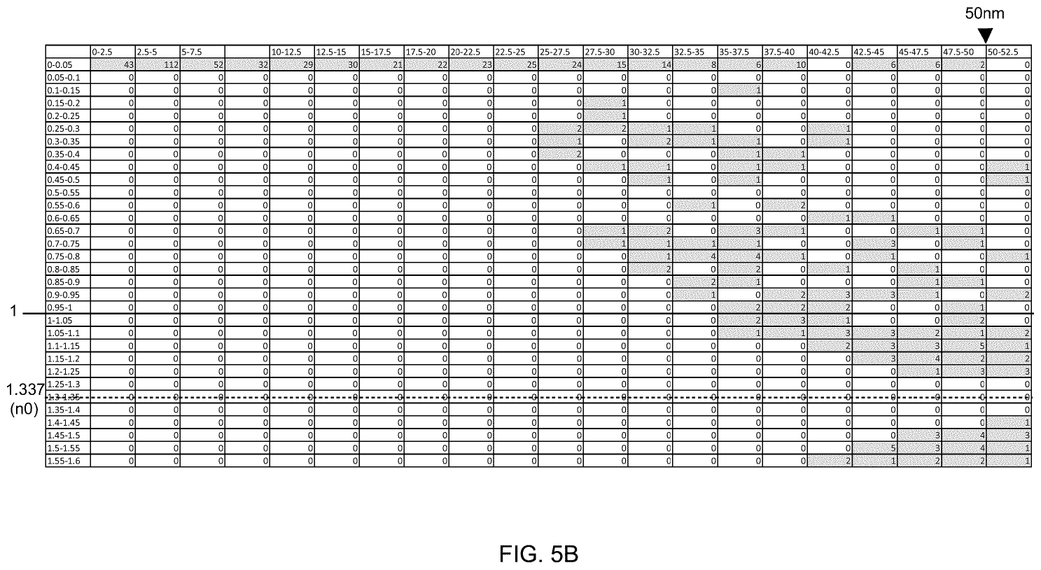

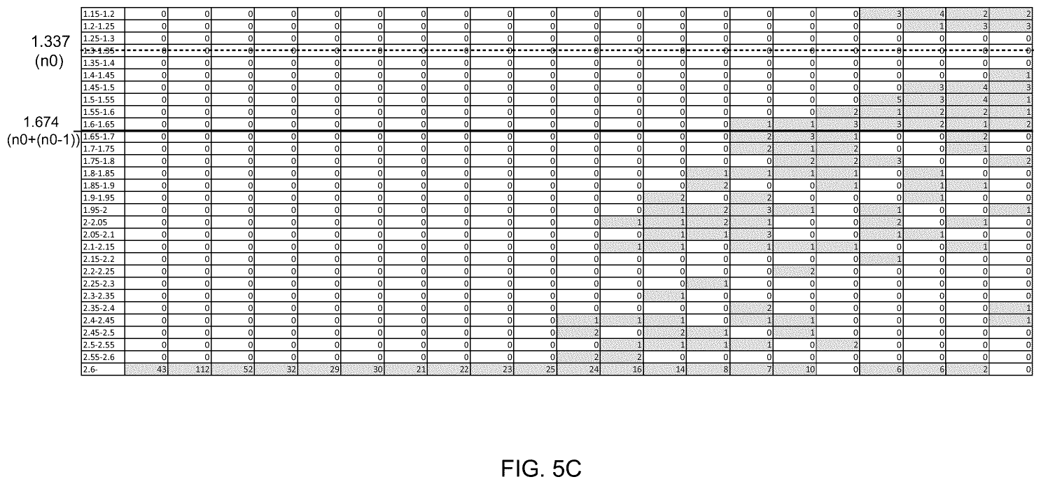

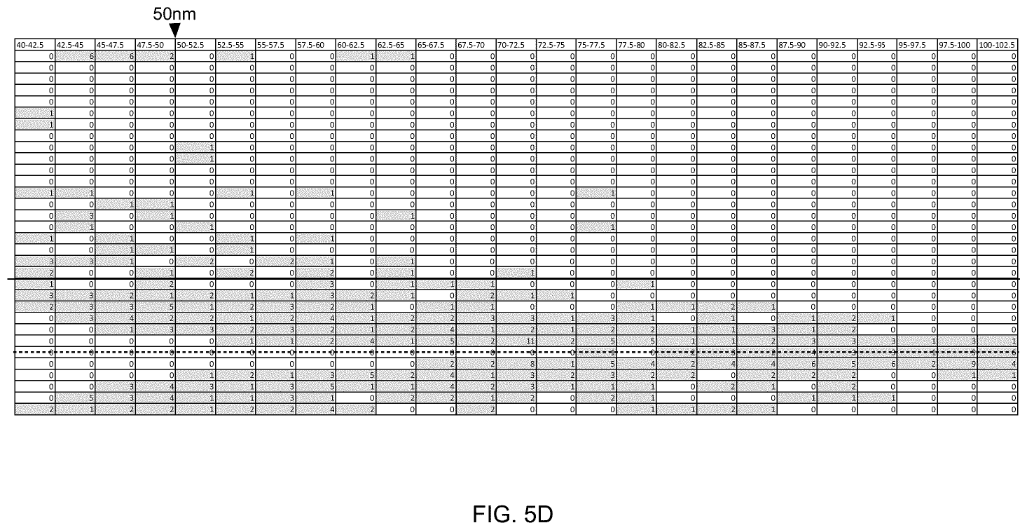

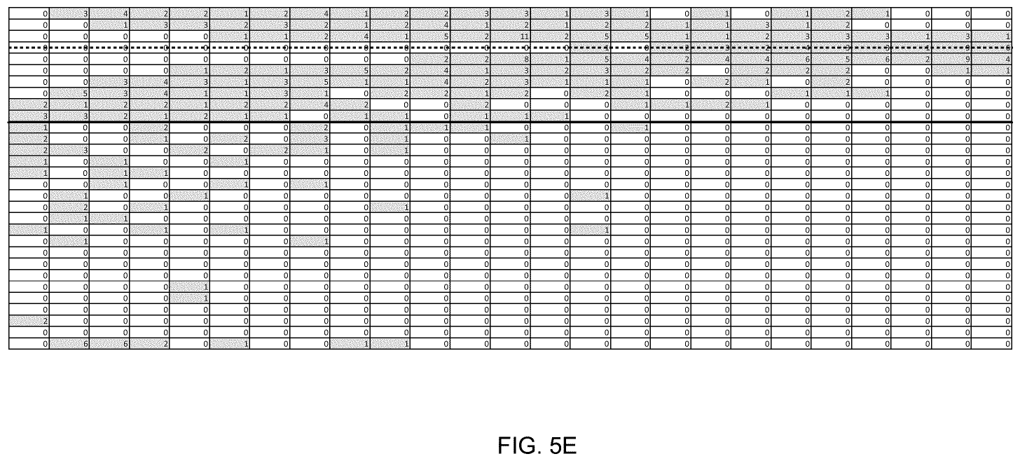

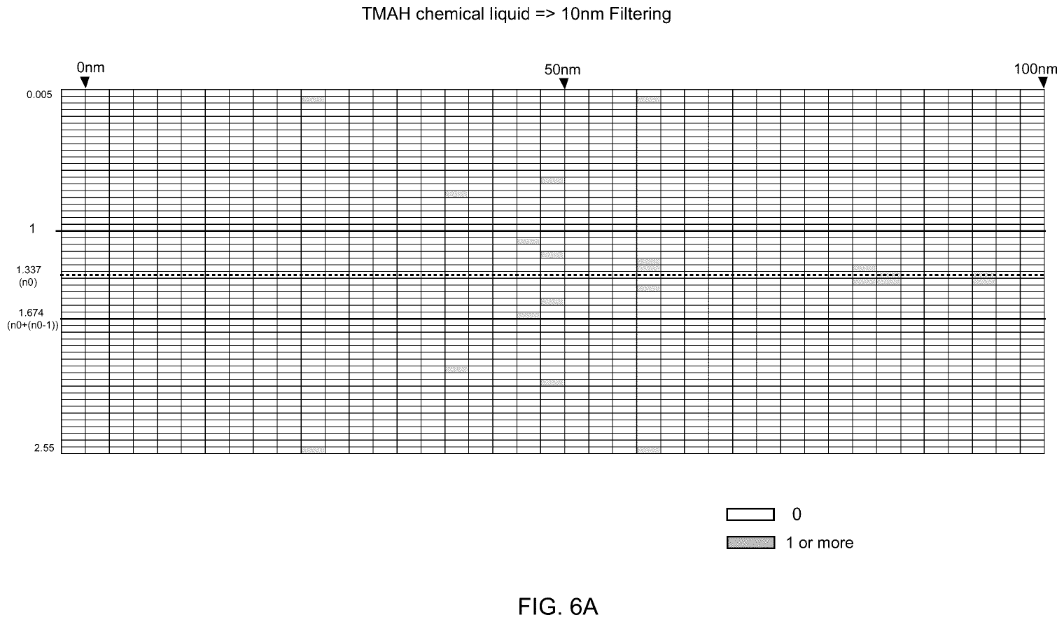

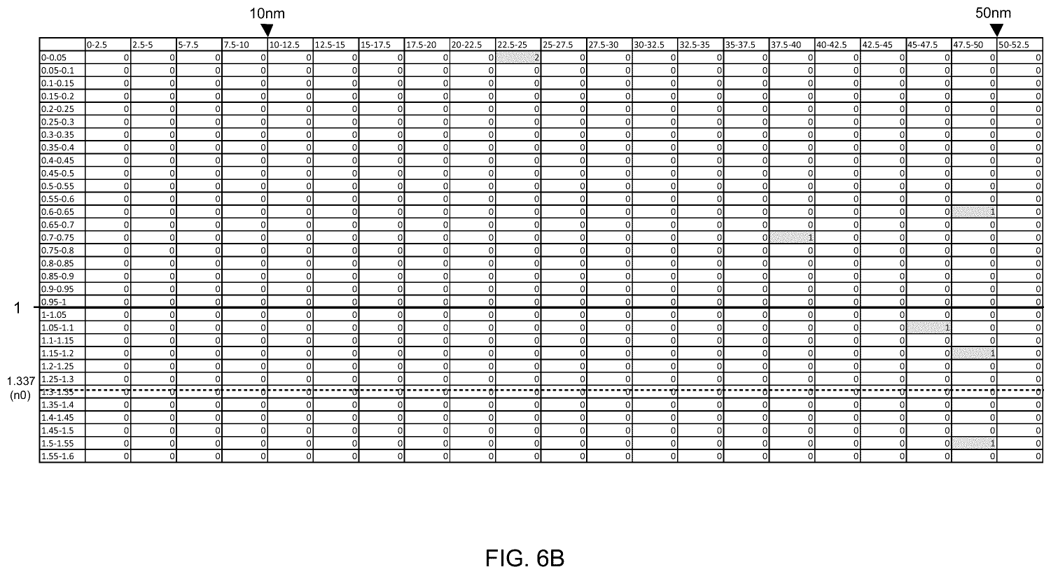

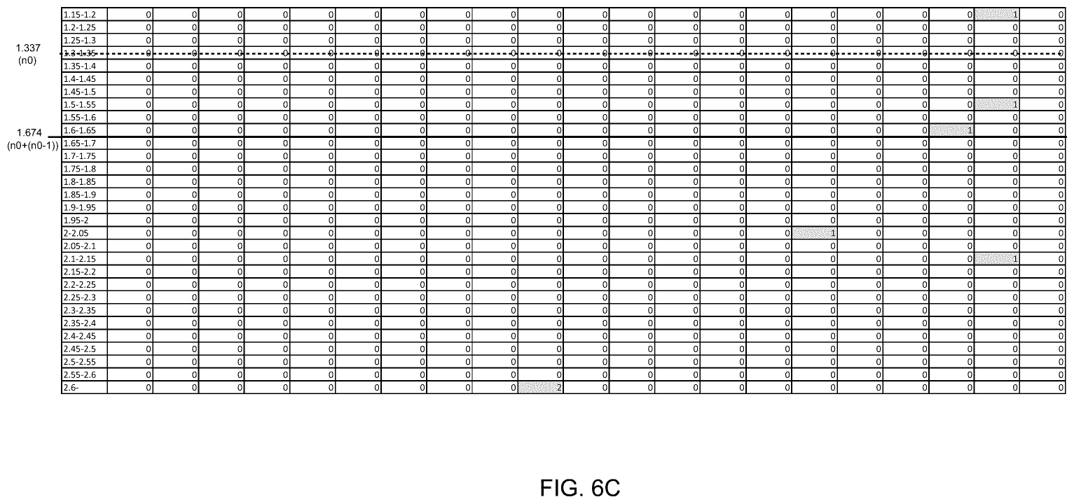

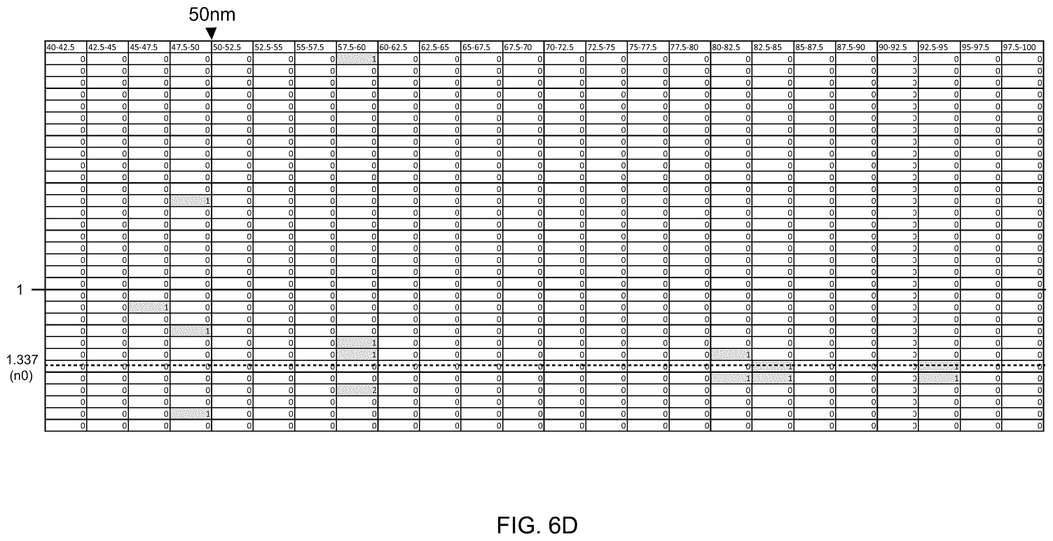

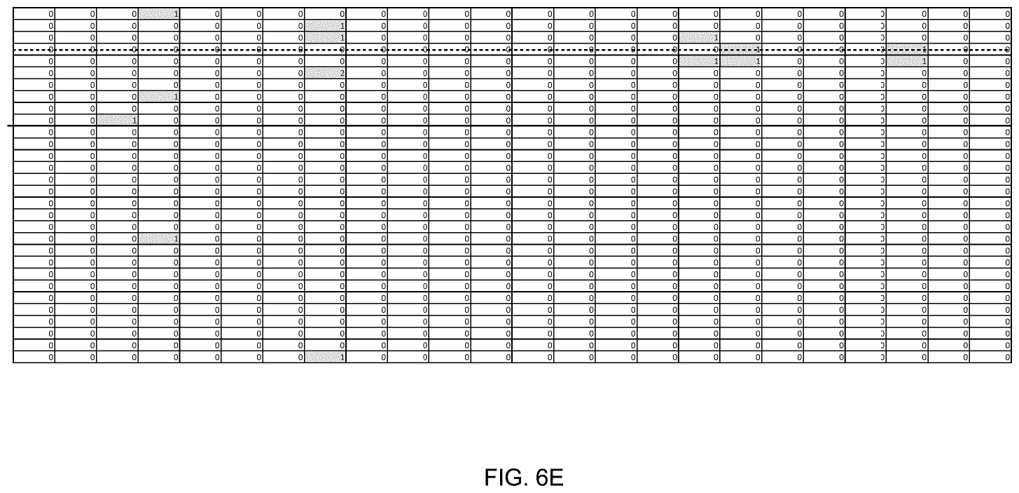

FIG. 5 and FIG. 6 are more specific examples of evaluating liquids containing the defects.

When the sum of the number of defect detections in the range of the refractive index n>n0+(n0−1) is a(1) and the sum of the number of defect detections in the range of the refractive index n<1 is a(2), the number of the first particles M in the liquid can be expressed by the following equation.

$$( a ( 1 ) + a ( 2 ) ) / 2 = number of the first particles M \qquad ( 3 )$$

When the sum of the measured values in the refractive index n of n0+(n0−1)≥n≥1 is represented by a(3), the number of the bubbles B or the second particles P in the liquid can be expressed by the following equation.

$$a ( 3 ) / 2 = Number of the bubbles B or the second particles P \qquad ( 4 )$$

Further, by applying a(1), a(2), and a(3) in a certain defect diameter d to the above equations, the number of the first particles M in the defect diameter d, the number of the bubbles B or the second particles P can also be obtained.

In both equations, the sum of the measurements in each defect species is divided by 2, because the refractive index n obtained from equation (2) has two solutions for each detected defect.

The defect diameter d determined by the calculating unit 62, and the distribution of the defects detected from the refractive index n are shown in FIG. 5 and FIG. 6. FIG. 5 shows the distribution of the defects in TMAH after passing through the filter of the pore size of 50 nm. FIG. 6 shows the distribution of the defects in TMAH after passing through the filter of the pore size of 50 nm and further passing through the filter of the pore size of 10 nm. The horizontal axis indicates the defect diameter d, and the vertical axis indicates the refractive index n.

In FIG. 5 and FIG. 6, the defect diameter d (horizontal axis) is divided into 2.5 nm in the range of 0 to 100 nm, and the refractive index n (vertical axis) is divided into 0.05 in the range of 0 to 2.6 to show the number of defect detections in each region. In the distribution diagram, the areas where one or more defects are detected are colored in the darkest color.

For example, consider determining the number of the first particles M, or the bubbles B and the second particles P, from FIG. 5 and FIG. 6. In this case, since the refractive index of TMAH is 1.337, the number of the first particles M is the sum of the number of defect detections in the range of the refractive index n>1.674 and n<1 divided by 2. The number of the bubbles B or the number of second particles P is the sum of the number of defect detections in the range of 1.674≥n≥1 divided by 2.

From FIG. 5, in the case of the 50 nm filter, one or more defects are detected in an area where the defect diameter d is 30-50 nm. In particular, the number of defect detections is large in the range where the refractive index is n>1.674 and n<1. Therefore, it can be seen that many metallic particles, the bubbles, or other particles are passing through. On the other hand, from FIG. 6, in the case of the 10 nm filter, the number of defect detections is small in the range where the defect diameter d is 30-50 nm and the refractive index is n>1.674 and n<1. From this, it can be seen that the metallic particles are decreasing. In this way, it can be seen that the evaluation method of the embodiment can more appropriately evaluate the filter elimination performance by FPT measurement in which the correct geometric diameter is obtained from the diffusion coefficient D.

The analyzing unit 60, the calculating unit 62, and the determining unit 64 are, for example, electronic circuits. The analyzing unit 60, the calculating unit 62, and the determining unit 64 are, for example, computers composed of a combination of hardware such as arithmetic circuits and software such as programs.

The database 66 is, for example, a storage device such as a semiconductor memory or a hard disk.

Next, the operation and the effects of the evaluation apparatus and the evaluation method according to the embodiment will be described.

Generally, standardized particles, such as polystyrene latex (Polystyrene Latex: PSL) particles, are used in evaluating the collection performance of the defects by the filter. The filtration test of the filter is performed using such standardized particles in evaluating the collection performance of the defect by the filter. The numbers of the standardized particles before and after filtration are detected using a liquid particle counter (Liquid Particle Counter: LPC) by the light scattering method. The average particle size of the standard particles with a removal rate of 99% is referred to as the rated filtration accuracy (μm).

The lower detection limit of the particle counter in the liquid by the light scattering method is about 40 nm. Therefore, in order to evaluate the rated filtration accuracy for particles having a particle size of 30 nm or less, the gold nanoparticle removal performance evaluation described in Japanese Patent Application Publication 2013-31835 is used. In the gold nanoparticle removal performance evaluation, the sample solution to which the gold nanoparticles are added is passed through the filter. The sample solution before and after the filtration is evaluated using an inductively coupled plasma mass spectrometry (Inductively Coupled Plasma Mass Spectrometry: ICP-MS) to evaluate the amount of the metallic particles in the sample solution. Thus, the collection performance of the filter is evaluated.

Here, consider evaluating the collection performance of the filter when the liquid containing a large number of the bubbles is passed through the filter. In the collection performance evaluation using PSL reference particles, the bubbles are detected by the LPC, and the bubbles and the particles cannot be separated and measured. Therefore, it is not possible to evaluate the collection performance of the filter. In addition, in evaluating the collection performance using gold nanoparticles, the effect of the bubbles on the collection performance is not known. Therefore, it is not possible to evaluate the collection performance of the filter.

In addition, in evaluating the collection performance using PSL reference particles, the defect detection technologies using the light scatter method are used to understand the number of the defects before and after the filter flow. However, in the light scatter method, the bubbles in the liquid is also detected as the defect. Therefore, it is not possible to evaluate the filter collection performance for the liquid containing a large amount of bubbles.

Thus, the evaluation apparatus according to the embodiment includes an evaluator including a column being capable of storing a liquid containing defects, the column being transparent, the defects containing a bubble, a first particle containing metal, and a second particle being different from the bubble and the first particle, an irradiator irradiating the liquid in the column with an irradiation light, an imager imaging a scattered light emitted from the defects by the irradiation light, an analyzer obtaining a diffusion coefficient of the defects from the imaged scattered light, a calculator calculating a particle size and a refractive index of the defects, a determiner determining whether the defects contain the bubble or the second particle, or the first particle; a filter filtering the liquid, the filter including an inlet and an outlet; a first pipe connecting the outlet of the filter and the evaluator.

According to the evaluation apparatus, it is possible to determine whether the defects contain the bubble or the second particle, or the first particle, by using the difference in the refractive index.

When the refractive index of the liquid Q to be measured is no, it is preferable to determine that the defects contain the first particle M when the refractive index n is larger than n0+(n0−1) or the refractive index n is smaller than 1. Further, it is preferable to determine that the defects contain the bubble or the second particle P when the refractive index n is 1 or more or the refractive index n is n0+(n0−1) or less.

The refractive index of the particle containing metal is larger than 2.0 or smaller than 0.5. For example, the refractive index of silver is 0.17. Further, the refractive index of gold is 0.34. Further, the refractive index of iron hydroxide oxide is 2.00. Further, the refractive index of chromium oxide (trivalent) is 2.50. Therefore, the defect having the refractive index larger than 2 or less than 0.5 may be determined as the first particle containing metal.

Further, the refractive index of nitrogen (the bubble) is 1. Further, the refractive index of ultrapure water is 1.33. Further, the refractive index of fluororesin is 1.35. The refractive index of silica (quartz) is 1.45. The refractive index of polystyrene latex (PSL) is 1.59. Therefore, it may be determined that the defect having the refractive index of 0.5 or more and 2 or less is the bubble or the second particle.

It is preferable that the evaluation apparatus 100 further includes the storage tank 2 in which the liquid Q is stored, the second pipe connecting the storage tank 2 and the inlet of the filter 80b, the liquid feed pump 4 provided at the second pipe and delivering the liquid Q from the storage tank 2 to the filter 80b, and the third pipe 16 connecting the evaluation unit 50 and the storage tank 2. This allows a slight difference in the filter collection performance to be evaluated more clearly by circulation of the liquid Q.

The liquid Q is preferably a chemical solution containing a quaternary amine, a chemical solution containing a quaternary amine and a surfactant, or a chemical solution containing water and a surfactant. The chemical solution containing a quaternary amine is preferably an aqueous tetramethylammonium hydroxide solution (TMAH) or an aqueous trimethyl-2-hydroxyethylammonium hydroxide solution. Such a chemical solution is a chemical solution frequently used in a semiconductor process. In addition, since such a chemical solution is a chemical solution that is easily foamed and difficult to be defoamed, the benefits of the evaluation apparatus and the evaluation method of the embodiment are particularly exerted.

The pore size of the filter 80b is preferably 100 nm or less. The defect having the particle size larger than 100 nm does not perform Brownian motion. Thus, it is difficult to determine the particle size d by the evaluation apparatus and the evaluation method of the embodiment.

According to the evaluation apparatus and the evaluation method of the embodiment, it is possible to provide the evaluation apparatus and the evaluation method capable of evaluating the collection performance of the filter for the liquid containing the bubble.

### EXAMPLES

Examples 1 to 3 will be described below.

### Example 1

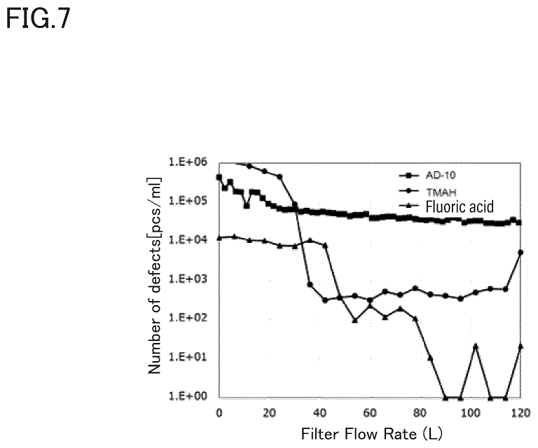

FIG. 7 is the filter flow rate dependency of the number of defects performed using the evaluation apparatus 100 of the embodiment for Example 1. In Example 1, hydrofluoric acid, AD-10 (a chemical solution containing tetramethylammonium hydroxide and a nonionic surfactant, manufactured by Tama Chemical Industry Co., Ltd.) and TMAH (tetramethylammonium hydroxide) were used as the liquid Q.

The first valve 32, the third valve 36 and the second valve 34 of the evaluation apparatus 100 were opened. The fifth valve 40, the sixth valve 42 and the fourth valve 38 of the evaluation apparatus 100 were closed. The liquid feed pump 4 was used to feed the liquid in the storage tank 2 to the filter 80b. The liquid Q filtered by the filter 80b was pumped through the second valve 34 and the first pipe 12b to the evaluation unit 50. The liquid Q evaluated for the defect was returned to the storage tank 2 by the third pipe 16. Subsequently, the liquid Q in the storage tank 2 was pumped to the filter 80b using the liquid feed pump 4. Thus, the liquid Q was circulated inside the evaluation apparatus 100, and the change of the defect in the liquid Q with time was measured.

As shown in FIG. 7, for hydrofluoric acid, the number of the defects decreased with increasing the amount of filter flow and decreased to the lower limit of detectability. This is because the bubbles contained in the hydrofluoric acid were defoamed.

On the other hand, for AD-10 and TMAH, the bubbles remain even after passing through the filter. Therefore, the reduction in the number of defects associated with the increase in the amount of filter flow is insufficient as compared with the case of hydrofluoric acid.

Quaternary amines have their own hydrophobic and hydrophilic groups. Therefore, the quaternary amine contributes to stabilize the bubbles by forming an electric double layer at the gas-liquid interface. As a result, the chemical solution containing the quaternary amine becomes a chemical solution that is difficult to defoam. Therefore, a chemical solution containing a quaternary amine can be preferably used for evaluating the collection performance of the filter when the liquid Q containing a large amount of the bubbles is passed through the filter. On the other hand, hydrofluoric acid can be preferably used for evaluating the collection performance of the filter when the liquid Q, which is difficult to foam, is passed through the filter.

Note that a chemical solution containing water and a surfactant is also an example of a chemical solution that is easily foamed.

### Example 2

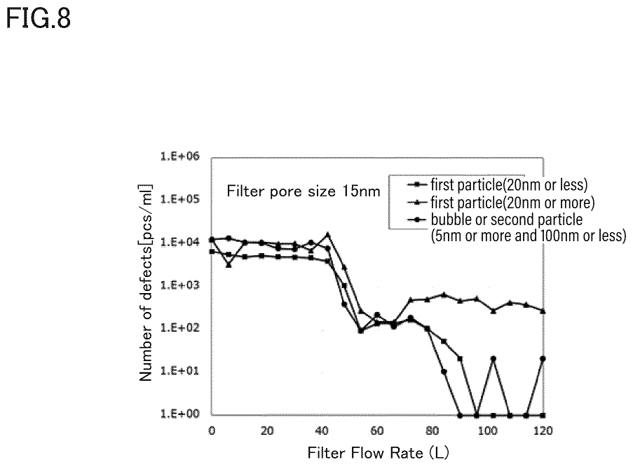

FIG. 8 is the filter flow rate dependency of the number of defects performed using the evaluation apparatus 100 of the embodiment for Example 2. In Example 2, hydrofluoric acid was used as the liquid Q. Hydrofluoric acid was 12 L stored in the storage tank 2. Otherwise, the time course of the defects in the liquid Q was measured in the same manner as in Example 1. The pore size of the filter 80b was 15 nm.

Black squares indicate the number of defects classified as “the first particle” with the particle size of 20 nm or more and 100 nm or less. Black triangles indicate the number of defects classified as “the first particle” with the particle size of 20 nm or less. Black circles indicate the number of defects classified as “the bubble or the second particle” with the particle size of 5 nm or more and 100 nm or less.

Immediately after the flow of the liquid to the filter 80b is started, the liquid Q is foamed by the circulation of the liquid Q. Therefore, the number of defects is large. However, over time, as the amount of filter flow increases, the defect numbers decrease.

The defect with the particle size of 20 nm or more and 100 nm or less reduced to about 1 pcs/ml. The defect of the particle size of 20 nm or more and 100 nm or less is larger than a pore size of the filter 80b.

On the other hand, the defect of the particle size of 20 nm or less decrease with increasing the amount of filter flow. However, when the amount of filter flow is increased to the vicinity of 60 L, the number of defects whose particle size less than 20 nm is about 1 pcs/ml.

As described above, by using the evaluation apparatus 100 and the evaluation method of the embodiment, it is possible to evaluate the filter collection effectiveness when the liquid Q that is difficult to foam, such as hydrofluoric acid, is passed through the filter.

### Example 3

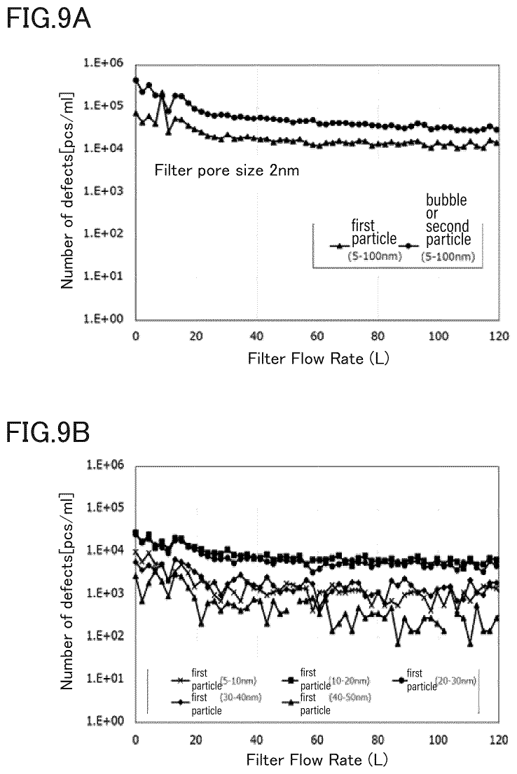

FIG. 9A-B are the filter flow rate dependency of the number of defects performed using the evaluation apparatus 100 of the embodiment for Example 3. In Example 3, AD-10 was used as the liquid Q. AD-10 was 12 L stored in the storage tank 2. The pore size of the filter 80b was 2 nm. Otherwise, the time course of the defects in the liquid Q was measured in the same manner as in Example 1 and Example 2.

In FIG. 9A, the black triangle indicates the number of defects classified as “the first particle” with the particle size of 5 nm or more and 100 nm or less. In addition, the black circle indicates the number of defects classified as “the bubble or the second particle” with the particle size of 5 nm or more and 100 nm or less. As compared to Example 2 (FIG. 6), even if the amount of filter flow is increased, the degree of reduction in the number of defects of “the first particle” and “the bubble or the second particle” is small. The number of defects of “the first particle” and “the bubble or the second particle” are nearly saturated at 30 L of the amount of filter flow. This indicates that the collection of the first particle by the filter is insufficient when the liquid that is likely to foam like AD-10 is used as the liquid Q because a phenomenon called “co-entrainment of metal-containing particles by the bubble” or “bubbles captured metallic particles” or “bubbles contained metallic particles” or “bubbles trapping metallic particles” or “bubbles enclosing metallic particles” occurs.

In FIG. 9B, the cross indicates the number of defects classified as “the first particle” with the particle size of 5 nm or more and 10 nm or less. Black square indicates the number of defects classified as “the first particle” with the particle size of 10 nm or more and 20 nm or less. Black circle indicates the number of defects classified as “the first particle” with the particle size of 20 nm or more and 30 nm or less. Black diamond indicates the number of defects classified as “the first particle” with the particle size of 30 nm or more and 40 nm or less. Black triangle indicates the number of defects classified as “the first particle” with the particle size of 40 nm or more and 50 nm or less.

The number of defects having the particle size of 40 nm or more and 50 nm or less tends to decrease with increasing the amount of filter flow even if the amount of filter flow becomes 30 L or more. Such an evaluation is enabled by the evaluation apparatus and the evaluation method of the embodiments, since it is possible to distinguish between the bubble or the second particle, and the first particle. As described above, by using the evaluation apparatus and the evaluation method of the embodiment, it is possible to evaluate the filter performance even if the liquid Q containing the bubble is used.

In addition, it can be understood that when the liquid Q containing a large number of bubbles is used, the filter that does not cause the coalescence of the fine particles by the bubble is preferable, in order to improve the collection efficiency of the metallic particles by the filter.

According to the evaluation apparatus and the evaluation method of the embodiment, it is possible to provide the evaluation apparatus and the evaluation method for evaluating the collection performance of the bubble containing the filter for the defect.

While certain embodiments have been described, these embodiments have been presented by way of example only, and are not intended to limit the scope of the inventions. Indeed, the evaluation apparatus and the evaluation method described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. An evaluation apparatus, comprising:
an evaluator including
a column being capable of storing a liquid containing defects, the column being transparent, the defects containing
a bubble,
a first particle containing metal, and
a second particle being different from the bubble and the first particle,
an irradiator irradiating the liquid in the column with an irradiation light,
an imager imaging a scattered light emitted from the defects by the irradiation light,
an analyzer obtaining a diffusion coefficient of the defects from the imaged scattered light,
a calculator calculating a particle size and a refractive index of the defects,
a determiner determining whether the defects contain
the bubble or the second particle,
or the first particle;
a filter filtering the liquid, the filter including an inlet and an outlet;
a first pipe connecting the outlet of the filter and the evaluator.

2. The evaluation apparatus according to claim 1,
wherein, when a refractive index of the liquid is n0,
the determiner determines that the defects contain the first particle M when the refractive index of the defects is larger than n0+(n0−1) or the refractive index of the defects is smaller than 1, and
the determiner determines that the defects contain the bubble or the second particle when the refractive index of the defects is 1 or more or the refractive index of the defects is n0+(n0−1) or less.

3. The evaluation apparatus according to claim 1, further comprising:
a storage tank storing the liquid;
a second pipe connecting the storage tank and the inlet of the filter;
a pump provided at the second pipe, the pump delivering the liquid in the storage tank to the filter; and
a third pipe connecting the evaluator and the storage tank.

4. The evaluation apparatus according to claim 1,
wherein the liquid is a chemical solution containing a quaternary amine, a quaternary amine and a surfactant, or water and a surfactant.

5. The evaluation apparatus according to claim 4,
wherein the liquid containing the quaternary amine is an aqueous tetramethylammonium hydroxide solution (TMAH) or an aqueous trimethyl-2-hydroxyethylammonium hydroxide solution.

6. The evaluation apparatus according to claim 1,
wherein a pore size of the filter is 100 nm or less.

7. An evaluation method, comprising:
filtering a liquid containing defects by a filter, the defects containing a bubble, a first particle containing metal, and a second particle being different from the bubble and the first particle;
delivering the filtered liquid to a column, the column being transparent;
irradiating the liquid in the column with an irradiation light;
imaging a scattered light emitted from the defects by the irradiation light;
obtaining a diffusion coefficient of the defects from the imaged scattered light;
calculating a particle size and a refractive index of the defects; and
determining whether the defects contain
the bubble or the second particle,
or the first particle.

8. The evaluation method according to claim 7,
wherein, when a refractive index of the liquid is no,
determining that the defects contain the first particle M when the refractive index of the defects is larger than n0+(n0−1) or the refractive index of the defects is smaller than 1, and
determining that the defects contain the bubble or the second particle when the refractive index of the defects is 1 or more or the refractive index of the defects is n0+(n0−1) or less.

9. The evaluation method according to claim 7,
wherein the liquid is a chemical solution containing a quaternary amine, a quaternary amine and a surfactant, or water and a surfactant.

10. The evaluation method according to claim 9,
wherein the liquid containing the quaternary amine is an aqueous tetramethylammonium hydroxide solution (TMAH) or an aqueous trimethyl-2-hydroxyethylammonium hydroxide solution.

11. The evaluation method according to claim 7, further comprising:
delivering the liquid in the column to the filter.

12. The evaluation method according to claim 7,
wherein a pore size of the filter is 100 nm or less.
